(19) United States
(12) Patent Application Publication
(10) Pub. No.: US 2011/0153445 A1
(43) Pub. Date: Jun. 23, 2011

(54) DIGITAL DATA MANAGEMENT SYSTEM AND METHOD

(76) Inventors: Wen-Cheng HUANG, Wugu Industrial Zone (TW); Chang-Chen Chien, Wugu Industrial Zone (TW); Chiu-Sung Chen, Wugu Industrial Zone (TW)

(21) Appl. No.: 12/774,268

(22) Filed: May 5, 2010

(30) Foreign Application Priority Data
Dec. 18, 2009 (TW) 098143736

(51) Int. Cl. H04L 9/32; H04M 1/00; G06Q 30/00

(52) U.S. Cl. 705/26.1; 713/168; 455/556.1

(57) ABSTRACT

A digital data management system and method, wherein, a serial number of a multi-media broadcasting device and digital data of a digital data platform are utilized to generate a key, and that is used to encipher said digital data. Upon downloading and storing said enciphered digital data by said multi-media broadcasting device, said key is used to decipher said digital data for broadcast. Through application of said digital data management system and method, management of protection of digital data authorization can be enhanced, such that a user is able to download said digital data to said multi-media broadcasting device for broadcasting, hereby eliminating the inconvenience of having to listen to music on-line.

### BACKGROUND OF THE INVENTION

1. Field of the Invention

The present invention relates to digital data copyright management system and method, and in particular to a digital data management system and method that is applicable in protecting digital data Intellectual Property Right.

2. The Prior Arts

Along with the ever increasing popularization of Information Technology and Internet, the framework of Mobile Communication is getting mature, as such, this will thoroughly and completely change the mode of cultural & information exchange. Presently, most of the literature works having copyright protection is presented in a digitalized form, such that people utilizing a computer can be connected to websites through the Internet to engage in various cultural activities, such as reading articles, viewing flashes/movies, or listening to broadcast of music. In this respect, a popular on-line music broadcasting platform KKbox is taken as an example for explanation. In order to use this on-line music broadcasting platform, a user must first register and subscribe to this website platform, pay the fees required, and then obtain the right to listen to the music, such that he/she may obtain an account number and then is authorized and allowed to select various music works in order to listen to the music of this platform, or download the music works to a specifically designated computer device for broadcast and listening.

However, for this kind of copyright protection of digitalized literature works, such as music, most of them are only allowed to be listened on the music platform, and only a small portion is authorized and allowed to be downloaded. Moreover, the user has to be equipped with a computer device or the like to get on network for entering into a website platform to select the music for listening, as such, its portability, instantaneity, and convenience is rather insufficient. In addition, the user must designate a specific computer device for connecting it to this website platform, then he is able to download the file that are authorized to be downloaded, such that the computer device other than the designated one is not allowed to download file as required, thus highlighting the inconvenience in application.

In view of the shortcomings and drawbacks of the prior art, the present invention proposes a digital data management system and method that is applicable in downloading digital data to multi-media device for broadcasting, so as to protect effectively the copyright of digitalized literature works.

### SUMMARY OF THE INVENTION

A major objective of the present invention is to provide a digital data management system and method, wherein, a part of a serial number of a multi-media broadcasting device and a part of data bytes of digital data are combined and coded into a key, then the key is used to encipher the digital data, such that only the authorized multi-media broadcasting device is allowed to decipher the digital data in proceeding with broadcasting, thus significantly increasing the effectiveness of copyright protection for the digital data.

Another objective of the present invention is to provide a digital data management system and method, wherein, the enciphered data file can be downloaded into a multi-media broadcasting device for storage, and when it is desired to broadcast the digital data, then the multi-media broadcasting device will decipher the enciphered data file for broadcasting, hereby effectively enhancing its convenience in application.

In order to achieve the above mentioned objective, the present invention provides a digital data management system and method, wherein, the digital data management system comprising: a multi-media broadcasting device and a digital data platform. The a multi-media broadcasting device is provided with a serial number, and is connected to the digital data platform via the Internet, and it transmits the serial number to the digital data platform; the digital data platform is provided with a data base for storing at least a digital data, and it fetches a part of fields of the serial number and encodes it into a first key, and fetches a part of data byte of the digital data and encodes it into a second key, and then it combines the first key and the second key into a key, and that is used to encipher the digital data into an enciphered data file. Subsequently, the multi-media broadcasting device downloads the enciphered data file for storage, and when it is desired to broadcast the enciphered data file, the multi-media broadcasting device will decipher the enciphered data file and put it into a register thereof in proceeding with broadcasting of the file.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a structure of a digital data management system according to the present invention;

FIG. 2 is a flowchart of the steps of a digital data management method according to the present invention;

FIG. 3 is a schematic diagram showing the ways of arranging and encoding the serial number of a multi-media broadcasting device into a first key according to the present invention;

FIG. 4 is a schematic diagram showing the ways of arranging and encoding data byte of digital data into a second key according to the present invention;

FIG. 5 is a schematic diagram showing the ways of combining the first key and the second key into a key according to the present invention;

FIG. 6 is a schematic diagram showing the ways of enciphering digital data into an enciphered data file according to the present invention; and

FIG. 7 is a schematic diagram showing the ways of deciphering an enciphered data file into a digital data according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides a digital data management system and method. Wherein, firstly, the serial number of the multi-media broadcasting device and data byte of digital data are arranged and encoded into a key, and that is used to encipher the digital data into an enciphered data file, and then this file is downloaded into a multi-media broadcasting device, and the multi-media broadcasting device will then use the key to decipher the enciphered data file and store it into its register for proceeding with the broadcast as required. In the following, the preferred embodiments will be described in detail in explaining the technical characteristics of the present invention.

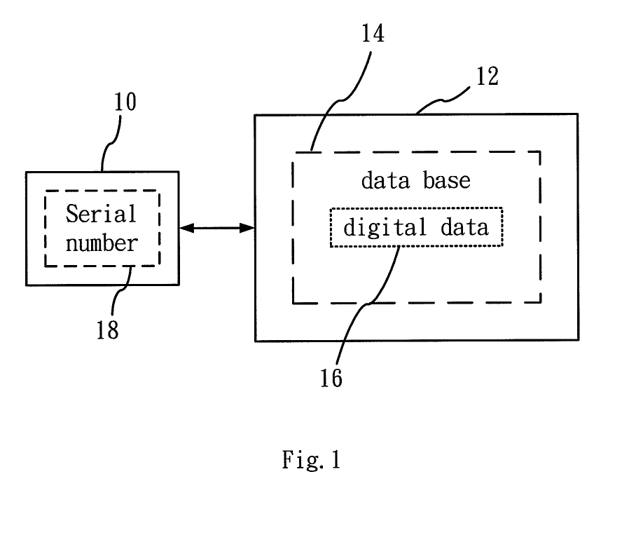

Refer to FIG. 1 for a schematic diagram of a structure of a digital data management system according to the present invention. As shown in FIG. 1, a multi-media broadcasting device 10 is connected to a digital data platform 12 via a public network, a wide band network, a mobile network, and the Internet of wireless network. The multi-media broadcasting device 10 is provided with a serial number 18, that includes the various fields as follows: year, week, machine code, guarantee period, manufacturer, difference version code, and sequence number, and this serial number 18 is transmitted to a digital data platform 12. The digital data platform 12 includes a data base 14 for storing at least a digital data 16 of a flash file, a video file, or an audio file, such that the digital data platform 12 will fetch a part of data fields of serial number 18 and a part of data byte of digital data 16 in arranging and encoding them into a key for enciphering digital data 16. The multi-media broadcasting device 10 will then download and store the enciphered digital data 16, and when it is desired to broadcast the digital data 16, the multi-media broadcasting device 10 will decipher the enciphered data and store it temporarily into its register (not shown) made of a Double Data Rate Synchronous Dynamic Random Access Memory (DDR) in proceeding with the broadcast as required.

In the above description, the structure of the digital data management system of the present invention is described, and in the following, the method of managing the digital data management system of the present invention will be described in detail.

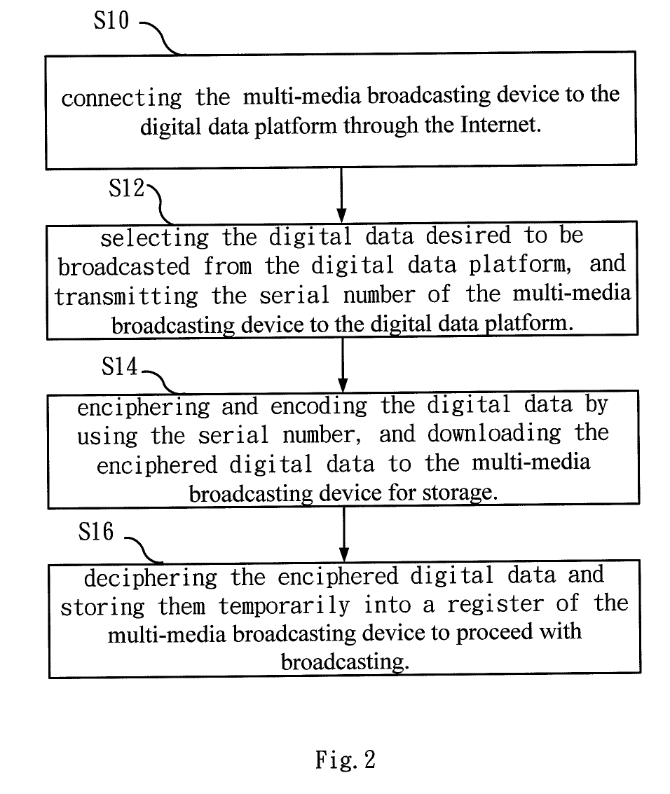

Refer to FIG. 2 for a flowchart of the steps of a digital data management method according to the present invention, meanwhile refer to FIG. 1. Firstly, as shown in step S10, connecting the multi-media broadcasting device 10 (for example, via the Internet) to the digital data platform 12.

Next, as shown in step S12, selecting the digital data 16 desired to be broadcasted from the digital data platform 12. For this purpose, the digital data 16 to be selected can be searched and obtained from the digital data platform 12 according to the file type and file contents, and after the selection, pay the fee as required through a cash flow system (not shown) of a network payment mechanism, so as to obtain the authorization of using the selected digital data 16, such that the serial number 18 of the multi-media broadcasting device 10 is uploaded to the digital data platform 12 after making the payment.

Afterwards, as shown in step S14, enciphering the digital data 16 by means of the serial number 18, and then downloading the enciphered digital data 16 to the multi-media broadcasting device 10 for storage.

Finally, as shown in step S16, when it is desired to broadcast the digital data 16, the multi-media broadcasting device 10 deciphers the enciphered digital data 16, and stores the deciphered digital data 16 temporarily into its register to proceed with the broadcast as required. When the digital data 16 are not yet broadcasted, the digital data 16 will not be deciphered, and they are stored in the multi-media broadcasting device 10 in an enciphered form.

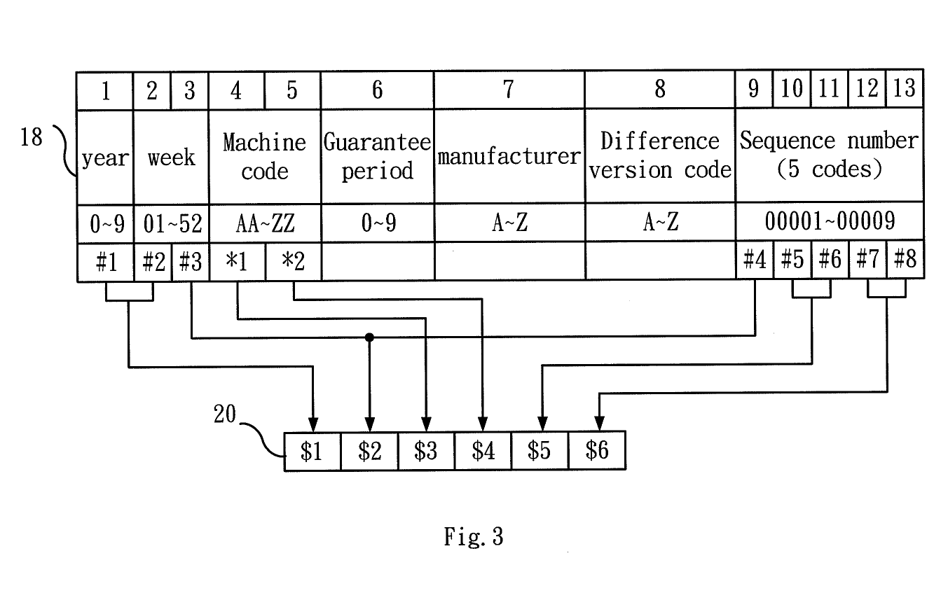

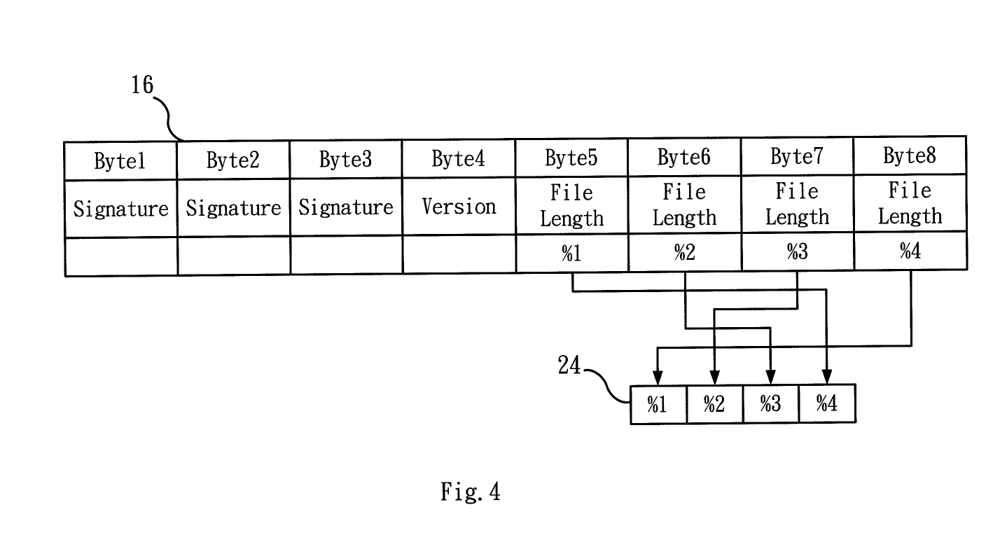

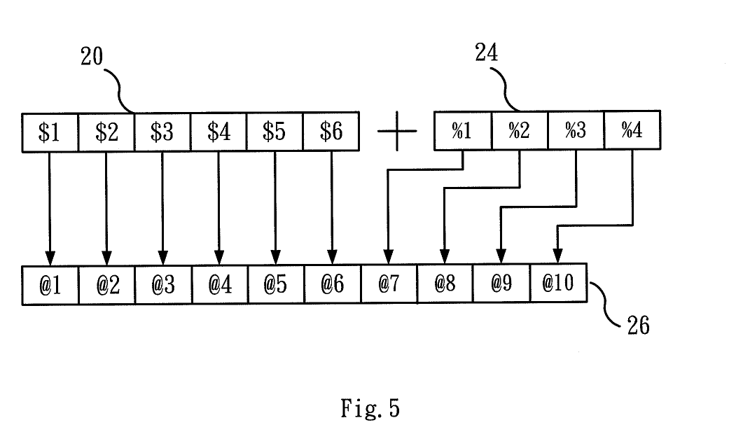

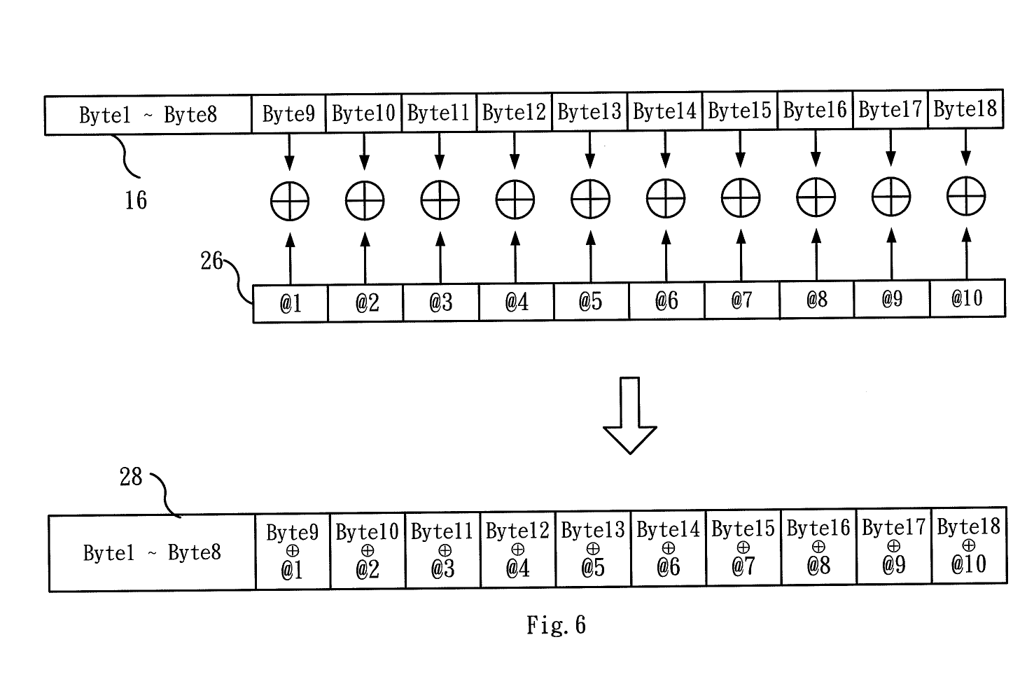

In the above description, the digital data management method of the present invention is described, in the following the enciphering and deciphering processes of steps S14 and S16 will be described in detail. In the step S14 mentioned above, the enciphering and encoding processes of digital data 16 using serial number 18 can be classified into four portions, refer to FIG. 3, FIG. 4, FIG. 5, and FIG. 6 respectively.

For the first portion, as shown in FIG. 3, arranging portions of data fields of the serial number 18 fetched and encoding them into a first key 20 of six codes ($1 $2 $3 $4 $5 $6). The serial number 18 includes the following data fields: year, week, machine code, guarantee period, manufacturer, difference version number, and sequence number, and each data field is assigned a representative code, the year data field is a code of numbers 0-9, the week data field is two codes of numbers 01-52, the machine code field is two codes of alphabets AA-ZZ, the guarantee period field is a code of numbers 0-9, the manufacturer field is a code of alphabets A-Z, the difference version field is a code of A-Z, and the sequence code field is four codes of numbers 0001-9999. Wherein, the representative code of year (#1), the representative code of week (#2 and #3), the representative code of machine code (*1 and *2), and the representative code of sequence number (#4, #5, #6, #7, and #8) are arranged and encoded into a first key 20. In order to achieve this purpose, perform the following processes in sequence: combining the representative code of year (#1) and the representative code of week (#2) into a decimal number, and then through a hexadecimal conversion, converting and encoding it into a first code ($1) of the first key 20; combining representative code of week (#3) and the representative code of sequence number (#4) into a decimal number, and then through a hexadecimal conversion, converting and encoding it into a second code ($2) of the first key 20; converting the alphabets of machine codes (*1) and (*2) into decimal numbers according to their alphabetical sequence, and then through a hexadecimal conversion converting and encoding them into a third code ($3) and a fourth code ($4) of a first key 20; and finally, arranging the representative codes (#5) and (#6) of sequence number into a group, and the representative codes (#7) and (#8) of sequence number into another group respectively, and combining them into decimal numbers, and then through hexadecimal conversion, converting and encoding them into a fifth code ($5) and a sixth code ($6) of the first key 20 respectively.

For the above description, the serial number 18“917DN3NA08931” is taken as an example for explanation. Wherein, (#1) is 9, (#2) is 1, (#3) is 7, (*1) is D, (*2) is E, (#4) is 0, (#5) is 8, (#6) is 9, (#7) is 3, and (#8) is 1. As such, combining (#1) and (#2) into a decimal number 91, then through a hexadecimal conversion, it is converted into 5B($1); next, combining (#3) and (#4) into a decimal number 70, then through a hexadecimal conversion, it is converted into 46($2); then, (*1) is alphabet D, and the sequence of the alphabet is 4, then through a hexadecimal conversion, it is converted into 04($3); subsequently, (*2) is alphabet N, and the sequence of the alphabet is 14, then through a hexadecimal conversion, it is converted into 0E($4); then, combining (#5) and (#6) into decimal number 89, then through a hexadecimal conversion, it is converted into 59($5); and finally, combining (#7) and (#8) into decimal number 31, then through a hexadecimal conversion, it is converted into 1F($6). As such, the first key 20 obtained is “5B 46 04 0E 59 1F”.

For the second portion, as shown in FIG. 4, arranging and encoding a portion of data fields of the digital data 16 fetched into the 4 codes (%1%2%3%4) of the second key 24. Wherein, the contents of the fifth byte (Byte 5) to the eighth byte (Byte 8) of digital data 16 are cross-combined into the second key 24, such that the fifth byte (Byte 5) is the fourth code (%4) of the second key 24, the sixth byte (Byte 6) is the third code (%3) of the second key 24, the seventh byte (Byte 7) is the second code (%2) of the second key 24, and the eighth byte (Byte 8) is the first code (%1) of the second key 24.

For the third portion, as shown in FIG. 5, and also refer to FIGS. 3 and 4 at the same time. Wherein, the first key 20 generated by the first portion and the second key 24 generated by the second portion are combined into a key 26, such that the first key 20 and the second key 24 are combined into a key 26 of ten codes (@1 @2 @3 @4 @5 @6 @7 @8 @9 @10), wherein, the first key 20 constitutes the former 6 codes of the key 26, and the second key 24 constitutes the latter 4 codes of the key 26.

For the fourth portion, as shown in FIG. 6, and also refer to FIG. 5 at the same time. Wherein, key 26 is utilized to encipher digital data 16, such that key 26 is used to perform exclusive OR operations on the digital data 16 starting from its ninth byte (Byte 9). As such, through the exclusive OR operations of key 26 on the digital data 16 from its ninth byte (Byte 9) to eighteenth byte (Byte 18), thus obtaining an enciphered data file 28, such that the multi-media broadcasting device 10 will download the enciphered data file 28 for storage as required.

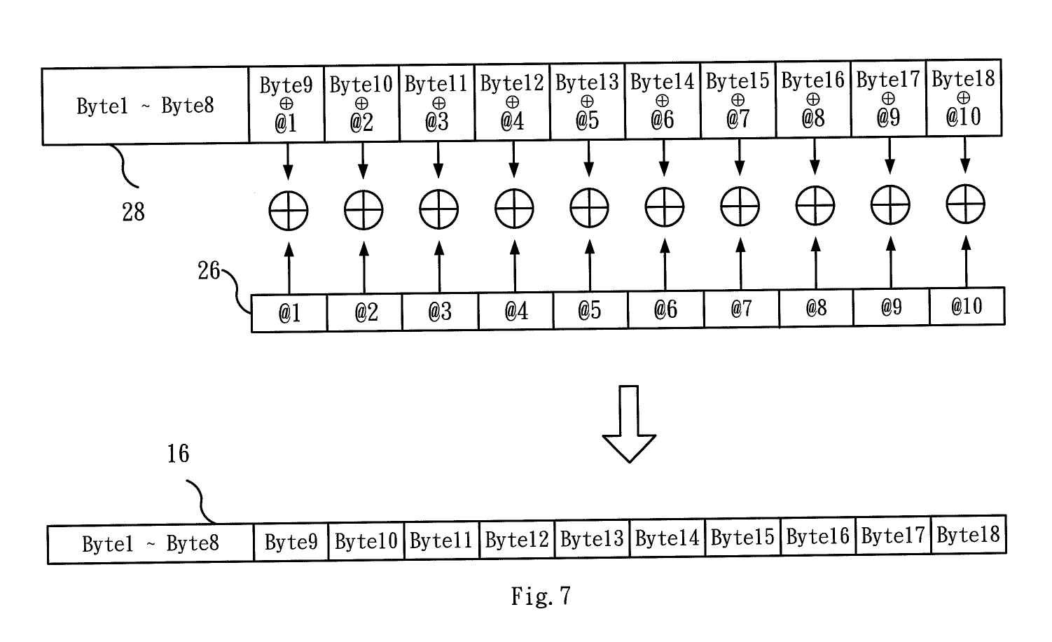

As mentioned above, after downloading the enciphered data file 28 by the multi-media broadcasting device 10, then as shown in step S16, the multi-media broadcasting device 10 will decipher the digital data 16 of the enciphered data file 28 in proceeding with the broadcast as required. As shown in FIG. 7, the multi-media broadcasting device 10 deciphers the digital data 16 of the enciphered data file 28 from its ninth byte (Byte 9) to its eighteenth byte (Byte 18) through performing the exclusive OR operations by means of the key 26, hereby restoring the original digital data 16, and storing them into a register of the multi-media broadcasting device 10.

Through the description of the embodiments mentioned above, it can be known that, in the present invention, the serial number 18 of a multi-media broadcasting device 10 and the data byte of digital data 16 are utilized to form a key 26, and that is used to encipher the digital data 16, such that upon obtaining the copyright authorization of the digital data 16, only one multi-media broadcasting device 10 is allowed to download and then decipher the enciphered digital data 16 in proceeding the broadcast as required. In addition, the multi-media broadcasting device 10 can be a mobile network device connected with a digital data platform 12, so that upon obtaining authorization for broadcasting the digital data 16, the multi-media broadcasting device 10 is allowed to download directly the enciphered data file 28 and store it therein; or the multi-media broadcasting device 10 can be installed in a computer device, a mobile communication device, or a personal digital assistant (PDA), and it is connected to a digital data platform 12 through the devices mentioned above, and upon obtaining the authorization of utilizing the digital data 16, downloads the enciphered data file 28 to the devices mentioned above, and then through copying, transfers the enciphered data file 28 from these devices to the multi-media broadcasting device 10 itself. Moreover, a data base 14 included in the digital data platform 12 can be monolithically installed, and is connected to the digital data platform 12 through the Internet.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A digital data management system, comprising:
a multi-media broadcasting device, provided with a serial number; and
a digital data platform, provided with at least a digital data, said serial number of said multi-media broadcasting device is transmitted to said digital data platform, which fetches data fields of said serial number for arranging and encoding them into a first key, and fetches data bytes of said digital data for arranging and encoding them into a second key, then combines said first key and said second key into a key, and then utilizes said key to encipher said digital data into an enciphered data file, and then downloads said enciphered data file into said multi-media broadcasting device for storage.

2. The digital data management system as claimed in claim 1, wherein
said serial number includes various data fields as follows: year, week, machine code, guarantee period, manufacturer, difference version code, and sequence number.

3. The digital data management system as claimed in claim 1, further comprising:
a data base for storing said digital data.

4. The digital data management system as claimed in claim 1, wherein
said digital data platform is connected to said multi-media broadcasting device through the Internet.

5. The digital data management system as claimed in claim 4, wherein
said Internet is a public network, a wideband network, a mobile network, and a wireless network.

6. The digital data management system as claimed in claim 1, wherein
said serial number is converted from a decimal number into a hexadecimal number for encoding.

7. The digital data management system as claimed in claim 1, wherein
said digital data are stored in a file of following: a flash file, a video file, or an audio file.

8. The digital data management system as claimed in claim 1, wherein
said multi-media broadcasting device is a mobile network device connected directly to said digital data platform, and said enciphered data file is downloaded into said multi-media broadcasting device for storage.

9. The digital data management system as claimed in claim 1, wherein
said multi-media broadcasting device is installed in a computer device, a mobile communication device, or a personal digital assistant (PDA), and said enciphered data file is downloaded into said computer device, said mobile communication device, or said personal digital assistant (PDA), and is copied and stored in said multi-media broadcasting device.

10. The digital data management system as claimed in claim 1, wherein
when it is desired for said multi-media broadcasting device to broadcast said stored enciphered data file, it deciphers said enciphered data file and restores it into said digital data, and stores said digital data into a register in said multi-media broadcasting device in proceeding with broadcasting.

11. The digital data management system as claimed in claim 10, wherein
said multi-media broadcasting device deciphers said enciphered data file through performing said exclusive OR operations on said key and said enciphered data file.

12. The digital data management system as claimed in claim 10, wherein
said register is a Double Data Rate Synchronous Dynamic Access Memory (DDR).

13. A digital data management method, comprising the following steps:
connecting a multi-media broadcasting device to a digital data platform;
selecting at least a digital data desired to be broadcasted from said digital data platform, and transmitting a serial number of said multi-media broadcasting device to said digital data platform; and
encoding said digital data into an enciphered data file through utilizing said serial number, and downloading said enciphered data file into said multi-media broadcasting device for storage.

14. The digital data management method as claimed in claim 13, wherein
in said step of selecting said at least a digital data desired to be broadcasted, payment is made through a cash flow system, thus realizing utilization authorization of said selected digital data.

15. The digital data management method as claimed in claim 14, wherein
said cash flow system is a network payment mechanism.

16. The digital data management method as claimed in claim 13, wherein
in said step of encoding said digital data into said enciphered data file, fetching various data fields of said serial number and arranging and encoding them into a first key, and fetching data bytes of said digital data and arranging and encoding them into a second key, then combining said first key and said second key into a key.

17. The digital data management method as claimed in claim 16, wherein
performing exclusive OR operations on said digital data and said key in creating said enciphered data file.

18. The digital data management method as claimed in claim 16, wherein
said serial number is converted from a decimal number into a hexadecimal number for encoding.

19. The digital data management method as claimed in claim 16, further comprising:
a step of deciphering said enciphered data file, wherein, said multi-media broadcasting device performs said exclusive OR operations on said key and said enciphered data file for restoring said enciphered data file into said original digital data, and storing them in a register of said multi-media broadcasting device temporarily in proceeding with said broadcast as required.

20. The digital data management method as claimed in claim 13, wherein
in said step of selecting at least a digital data desired to be broadcasted, searching said digital data to be selected in said digital data platform according to file type and file contents.
